(19) United States
(12) Patent Application Publication
(10) Pub. No.: US 2009/0313057 A1
(43) Pub. Date: Dec. 17, 2009

(54) SELF-SERVICE USER DEVICE MANAGER

(75) Inventors: Janet Kay Slayton, Gladstone, MO (US); Stephen R. Crowley, Huntersville, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 12/137,399

(22) Filed: Jun. 11, 2008

(51) Int. Cl. G06Q 10/00

(52) U.S. Cl. 705/7; 705/1

(57) ABSTRACT

A central management system may manage a plurality of self-service user devices. A user or customer of a business entity operating one or more of the self-service user devices may place an order for a self-service user device, such as the sale of a new self-service user device, a remodel or update of the current self-service user device, the de-installation or relocation of a self-service user device or the like. The self-service user device may be designed and configured to operate with the self-service user device management system. During the operation of the self-service user device, maintenance may be performed. A self-service user device profile may be generated that stores and compiles information relating to the order, the sale, the configuration, the operational tracking, or any other suitable information. Information relating to one or more self-service user devices may be shared between one or more users.

### FIELD OF THE TECHNOLOGY

Aspects of the disclosure relate to the deployment and management of self-service user devices. More specifically, aspects of the disclosure relate to selection, deployment, and implementation of a self-service user device.

### BACKGROUND

Many industries have installed self-service user devices that are configured to interact with customers. The self-service user devices can be positioned on site of a business or at a remote location. For example, many business entities have adapted to their customers' needs by providing self-service user devices that facilitate business transactions without the need to involve a human representative of the business. Many businesses offer automated self-service user devices, kiosks, and the like for accessing user accounts and conducting business transactions between a user and the business.

In particular, the financial industry has adapted its customer services by deploying self-service user devices such as automated teller machines (ATMs), account management kiosks, cash recyclers, point-of-sale terminals, and other remotely operated user devices. Many of these self-service user devices are located at or near the financial institution, such as an ATM positioned at a financial institution, for providing customers with a self-service option. Financial institutions have positioned self-service user devices at convenient remote locations such as a shopping mall, an office building, a restaurant, a grocery store, or the like. Many business entities strategically place the self-service user devices in a location that is easily accessible and convenient for the users. As such, business entities must carefully sell, install, deploy, and maintain any self-service user device that is associated with their business.

The locations at which the self-service user devices are positioned may be owned, leased, operated by, or otherwise monitored by the business entity. Each step of the process is usually performed by a different portion of the business entity, which is inefficient, costly, and prone to errors. Further, many business entities would like to customize the self-service user device, the user interface, the user experience, or the like, but are unable to do so because of the additional cost and time that such customization would require.

Additionally, many business entities would like to track the operation and maintenance of the self-service user device. The business entity typically tracks information relating to the usage, profitability, maintenance, or other operational characteristics relating to the self-service device. However, most of the data collection occurs independently and collected data is not frequently or easily shared between portions of the business entity.

The business entity and/or a service provider will perform one or more of the design, the site selection, the installation, the deployment, the maintenance, the cleaning, the security monitoring, and the like of the self-service user devices. This distribution of responsibility for these tasks is costly, inefficient, and prone to errors. Oftentimes, communication between the parties involved with the self-service user device may be strained or otherwise complicated because it requires the same or similar data to be collected and/or stored by multiple portions of the business entity.

### BRIEF SUMMARY OF THE INVENTION

Aspects of the present disclosure address one or more of the issues mentioned above by describing a system and method for managing self-service user devices. The following presents a simplified summary of the disclosure in order to provide a basic understanding of some aspects of the systems and methods of managing self-service user devices. It is not intended to identify key or critical elements of the invention nor is it intended to delineate the scope of the invention. The following summary merely presents some concepts of the disclosure in a simplified form as a prelude to the more detailed description provided below.

An aspect of the invention discloses a method of managing a self-service user device, comprising the steps of: (1) receiving information relating to an order for a self-service user device; (2) designing the self-service user device; (3) selecting the site for the self-service user device; (4) installing the self-service user device at the site; (5) configuring the self-service user device to a self-service user device management system for managing a plurality of self-service user devices; (6) deploying the self-service user device so that it is operational with the self-service user device management system; and (7) maintaining a self-service user device during operation of the self-service user device; wherein the self-service user device profile includes one or more self-service user device operational activities related to the self-service user device, each of the self-service user device operational activities having one or more action items managed by the self-service user device management system.

In another aspect of the invention, a method of managing a fleet of self-service user devices operated by a business entity, may comprise the steps of: A method of managing a fleet of self-service user devices operated by a business entity, comprising: (1) receiving a request at a central management system for a new self-service user device to be added to the fleet of self-service user devices, the new self-service user device positioned at a self-service user device site; (2) designing the new self-service user device; (3) installing the new self-service user device at the self-service user device site; (4) configuring the new self-service user device with the central management system, the central management system capable of integrating order, deployment, operational management, and maintenance of the fleet of self-service user devices; (5) compiling information relating to the order, the deployment, the operational management, and the maintenance of each of the self-service user devices in the fleet; and (6) storing the information in a self-service user device profile that is accessible by a plurality of users, the self-service user device profile stored on a server positioned at a remote location from the new self-service device; wherein the central management system is accessible by at least two users, the central management system and the fleet of self-service user devices operated by a business entity.

### BRIEF DESCRIPTION OF THE DRAWINGS

The present disclosure is illustrated by way of example and not limited in the accompanying figures in which like reference numerals indicate similar elements and in which:

FIG. 1 illustrates a computing system in accordance with an aspect of the invention.

FIG. 2 is a flowchart illustrating a method of accessing a self-service user device management system, in accordance with an aspect of the invention.

FIG. 3 is a system accessing a self-service user device management system by multiple users, according to an aspect of the invention.

FIG. 4 illustrates a self-service user device management system having a fleet of self-service user devices, according to an aspect of the invention.

### DETAILED DESCRIPTION

In the following description of various example embodiments of the invention, reference is made to the accompanying drawings, which form a part hereof, and in which are shown by way of illustration various example devices, systems, and environments in which aspects of the invention may be practiced. Additional specific arrangements of parts, example devices, systems, and environments may be utilized and structural and functional modifications may be made without departing from the scope of the present invention. The various figures in this application illustrate examples of a system of managing self-service user devices. When the same reference number appears in more than one drawing, that reference number is used consistently in this specification and the drawings to refer to the same or similar parts throughout.

### I. General Description of a System to Manage Self-Service User Devices

In general, as described above, aspects of the invention relate to managing a self-service user device. In accordance with at least some aspects of the invention, a method of managing a self-service user device may comprise: A method of managing a self-service user device, comprising: (1) receiving information relating to an order for a self-service user device; (2) designing the self-service user device; (3) selecting the site for the self-service user device; (4) installing the self-service user device at the site; (5) configuring the self-service user device to a self-service user device management system for managing a plurality of self-service user devices; (6) deploying the self-service user device so that it is operational with the self-service user device management system; and (7) maintaining a self-service user device during operation of the self-service user device; wherein the self-service user device profile includes one or more self-service user device operational activities related to the self-service user device, each of the self-service user device operational activities having one or more action items managed by the self-service user device management system.

Management of the self-service user device may be performed by any entity or a group of entities. Portions or steps of the management may be performed by the entity itself, employees, independent contractors, vendors, or any other entity. Responsibility of the management may be assigned in any suitable manner.

The self-service user device may be a computing device that may be configured to directly interact with a user, such as a customer. The self-service user device oftentimes has a user interface that may facilitate the interaction between the user and the business entity. The self-service user device may be configured to perform any transaction between the user and the entity. In some examples, the self-service user device has a monitor or other audio or visual inputs devices for facilitating the interaction between the user and the self-service user device.

For example, the business entity may be a financial institution and the self-service user device may be an ATM, an account management kiosk, a cash recycler, a point-of-sale terminal, and/or any other remotely operated user device. The self-service user device also may be a computing device that is operated by a user, such as a personal computer, a laptop, a mobile phone, a personal digital assistant or the like. For example, the self-service user device may provide a user with access to the self-service user device management system over a computer network, such as the Internet. The management system may require that the user enter security information (e.g., a username and/or password) to be permitted to access the management system. Any suitable computing device may be used to provide an interface between the user and the management system.

The self-service user device may be positioned in any location. The self-service user device may be positioned as an ATM at or near the financial institution or at a remote location away from the financial institution. Many example self-service user devices may be directly linked to a self-service user device network. For example, a financial institution may deploy a fleet of ATMs and each ATM may be coupled to an ATM network. The ATM network may provide each ATM with access to the management system and any other application or feature that may be offered to the user through the ATM.

An order may be created for a self-service user device. Any entity may create an order, including, but not limited to, a customer, a vendor, an/or the business entity itself. Information relating to the order may be received by the self-service user device management system. The order may be submitted to the self-service user device management system in any suitable method, including, but not limited to, via an interaction at the self-service user device, through a representative of the business entity, through a website configured to receive orders relating to a self-service user device, or any other method.

The order may be a sale of a new self-service user device, a repair or upgrade to an existing self-service user device, installation or de-installation of a self-service user device, remodel of a self-service user device, relocation of a self-service user device, or any other activity that may affect the self-service user device.

In some example systems, a new self-service user device may be ordered. The order may include a sale of the self-service user device. The sale may include a sales tool, such as a sales representative or website that may help facilitate the sale of the new self-service user device. Any suitable sales tool may be implemented into the order.

An order for a new self-service user device may include designing the self-service user device. The design may include selecting suitable hardware and suitable software for the computing device. An interface may also be selected. The interface may include a monitor, a keyboard, a speaker and microphone combination, or any other audio, visual, or sensory input/output devices.

A site for the new self-service user device may be selected. The site may be selected before, during, or after the design of the self-service user device has been completed. The site may be any suitable location. In some examples, business entities select a convenient location for users of such self-service user devices. For example, a financial institution may intend to deploy one or more ATMs. The financial institution may select a site for the ATM that is at or near the financial institution or an affiliate of the financial institution, at a grocery store or other convenience store, a gas station, an office building, a retail store, a sporting arena, a restaurant, or any other suitable location. The site may be operated and/or maintained by the business entity or financial institution or may be independently maintained and/or operated by a third party.

In the previous example, a new self-service user device may have at least one hardware and at least one software. The user may be able to select the hardware and/or the software from a catalog or other grouping of options. The hardware and/or the software may be generally available to all or a portion of the users or may be customized to meet an individual user's needs.

The hardware and the software may be configured to a self-service user device management system. The self-service user device management system may be physically connected to a self-service user device network (“hardware configuration”). The software may be electronically coupled to properly function with the self-service user device management system. For example, the software may be installed on each self-service user device and may sync with the operating system of the self-service user device management system over a remote connection, such as a self-service user device network or the Internet. Alternatively, the software may be stored upon the self-service user device management system itself (e.g., on a self-service user device management system server) and the self-service user device may access the self-service user device server to run the software.

The self-service user device management system may be capable of managing more than one self-service user device. For example, a fleet of self-service user devices may be coupled to the self-service user device management system. One or more of the self-service user devices within the fleet may be owned and/or operated by one or more business entities. The business entities may or may not maintain the self-service user device management system. In one example, a self-service user device management system may be capable of supporting a plurality of fleets, a first fleet owned and operated by a first business entity and a second fleet owned and operated by a second business entity different from the first business entity. Any suitable arrangement self-service user devices may be operationally coupled to or be operated by the self-service user device management system.

The self-service user device may be installed at the selected site. The installation may include physically installing hardware at the site. The installation may also include installing additional hardware or software at any point along the connection between the site and the location at which the self-service user device management system is positioned. For example, the self-service user device management system may be stored on a server operated by a financial institution at a central location. A new self-service user device may be installed at a grocery store remotely located from the central location. The installation may require the physical installation of an ATM at the selected site. The installation also may require a new router or switch to facilitate the connection between the self-service user device and the server.

The self-service user device may be deployed within the self-service user device management system. For example, the self-service user device may be activated by directing power to the computing device, confirming that the proper physical connections are made between the self-service user device and the self-service user device management system, and initializing a user interaction or transaction at the self-service user device. During the deployment process, the self-service user device may become operational and may permit transactions to occur between the self-service user device and the business entity and/or self-service user device management system.

The self-service user device may also be maintained during its operation. Maintenance may include a repair to the hardware or software of the self-service user device; repair to the connection between the self-service user device and the self-service user device management system; routine maintenance or repair; preventative maintenance; and the like.

The self-service user device may have a profile that may include one or more self-service user device operational activities that may be related to the self-service user device. Each of the self-service user device operational activities may have one or more action items that may be managed by the self-service user device management system. The self-service user device profile may store, compile, or otherwise track information and images relating to the self-service user device.

An self-service user device operational activity may include one or more of asset management, productivity monitoring, manage workflow, gather information relating to one or more self-service user devices, issue notification tasks, compliance tracking, and the like. Asset management may include monitoring or managing one or more assets. Productivity monitoring may include monitoring and/or tracking transactions or other activity that occur at the self-service user device.

Managing workflow may include monitoring the progress of a project for the self-service user device, such as a project having multiple tasks or action items. Managing workflow also may include monitoring a self-service user device profile for additions, deletions, changes, and any other alterations of a portion of the self-service user device profile or an activity or task associated with the self-service user device. Managing workflow may include identifying one or more activities for the self-service user device, such as maintenance or tracking transactions. The activities may have one or more action items.

For example, a schedule may be created for the installation and deployment of a new self-service user device at the site. The schedule may include action items such as physical installation, configuration of the self-service user device to the self-service user device management system, compliance testing (i.e., confirming that the self-service user device meets regulatory standards), and a preventative maintenance schedule. Each of the action items may be assigned a goal date for completion. When an action item has been completed, the self-service user device profile may be updated to reflect the completion. If the goal date for completion of the action item is revised, the self-service user device profile may also be updated with the new information.

Some action items may be dependent upon the completion of one or more previous action items. For example, the installation of the self-service user device must be completed before the configuration of the self-service user device may begin, in some embodiments.

Information may be gathered that relates to one or more of the self-service user devices. Such information may include transaction history, financial tracking, compliance issues, captured images of the self-service user device itself, security tracking (i.e., a log of users attempting to use the self-service user device; video of a user attempting to use the self-service user device; etc.); and any other information relating to the self-service user device that may be suitable for gathering.

Transaction history may include monitoring use of the self-service user device. For example, transaction history may track and store information relating to each occurrence in which a user interacts with the self-service user device. Financial tracking may include tracking financial transactions that occur at the self-service user device. Financial tracking also may include monitoring sales, sending an alert if a forbidden or tagged transaction may be requested, monitoring sales executed at the self-service user device, and the like.

Compliance issues may include the initial and periodic confirmation that the self-service user device, the self-service user device management system, and the like comply with the regulations that may govern the operation of the self-service user device. For example, transactions occurring within the financial industry are often governed by regulations. Many financial institution customers utilize an ATM for conducting financial transactions with the financial institution. Information may be gathered regarding whether the operation of the self-service user device complies with the regulations governing the operation of the self-service user device.

Images and/or video of the physical condition of the self-service user device may be collected. Such images and/or video may assist in the determination of whether maintenance, remodel, upgrade, and the like should occur at a particular self-service user device. Images and video also provide security for the self-service user device. Real-time or delayed monitoring or recordation of an image or video of the users of the self-service user device may prevent breaches in security. Further, it may prevent problems such as vandalism, theft, and fraudulent use of the self-service user device.

A status may be assigned to one or more action items or activities. The status may indicate whether the action item has been changed, added, deleted, completed, or the like. The status of an action item may be pending, not-yet-begun, completed, or any other suitable indicator of the status of an action item. For example, when a first action item is completed, an alert may be sent to a person who is responsible for a second action item that must be completed after the first action item. The alert may indicate to that the first action item has been completed and that the person may begin work on the second action item. Each action item may be assigned to one or more people who are responsible for completing the action item.

The status information may be compiled and stored. The status information may be stored locally on the self-service user device or may be stored remotely at the self-service user device management system (i.e., the status information may be stored on the memory of the server). A report may be generated that includes the status information. The report may be generated periodically, such as daily, weekly, monthly, quarterly, or any other suitable time period. The report may also be generated when an action item has been completed, revised, deleted, and/or added. The report may be generated for any suitable reason.

A first entity and a second entity may be permitted to access the information gathered on the self-service user device. The first entity and the second entity may be permitted to access a portion of the information stored on the self-service user device management system relating to one or more self-service user devices in the fleet of self-service user devices. The first entity may be a first line of business or a “first department” of the business entity. The second entity may be a second line of business or a “second department” of the business entity. The first line of business and the second line of business may be permitted to share information that each line of business gathers about the self-service user device, the users operating the self-service user device, or any other information gathered or compiled relating to one or more of the self-service user devices.

Information relating to one or more self-service user devices may be stored within the self-service user device management system. Such information may be shared between any users that are permitted to access the self-service user device profile relating to a particular self-service user device. For example, a first line of business may perform a first function for a business entity and a second line of business may perform a second function for the business entity that is different than the first function. A new self-service user device may be deployed and the first line of business and the second line of business may be permitted to access information relating to the new self-service user device. The first function and the second function may share information and may integrate overlapping or common action items or other activities (e.g., maintenance and security may each record a video to monitor the physical condition of the self-service user device).

### II. Specific Examples of Managing a Self-Service User Device System

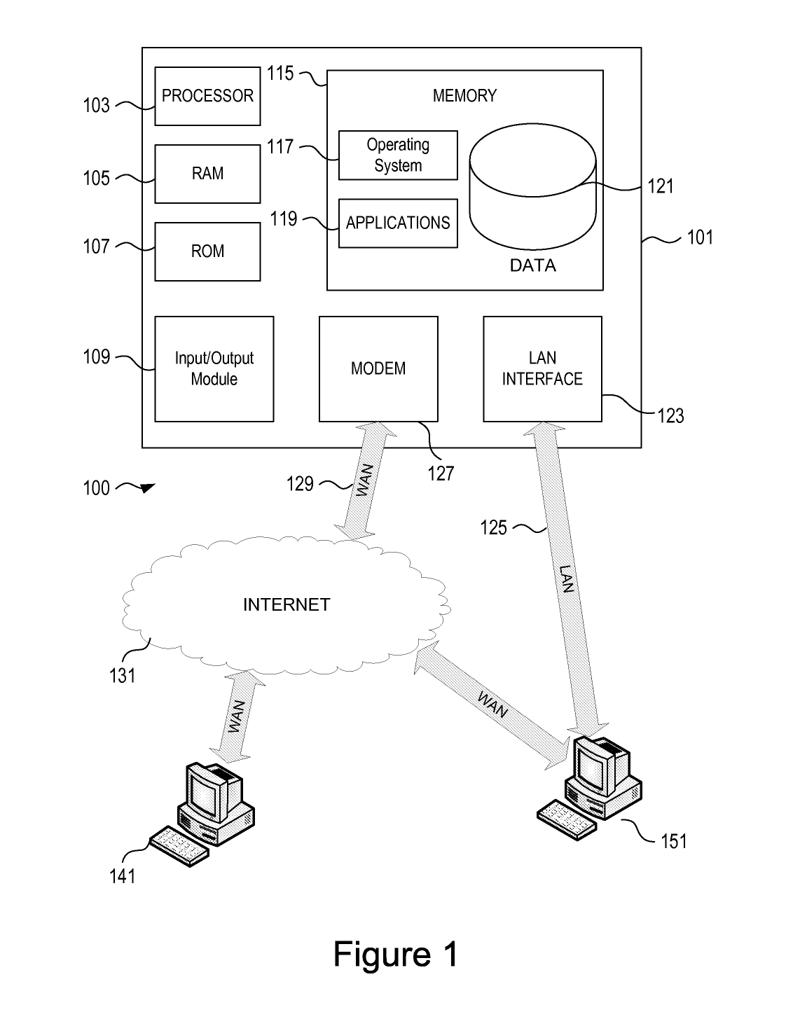

The system and method of managing a self-service user device system may be embodied in a computing system environment. FIG. 1 illustrates an example of a computing system environment 100 that may be used according to one or more embodiments of the invention. The computing system environment 100 is only one example of a suitable computing environment and is not intended to suggest any limitation as to the scope of use or functionality of the invention. The computing system environment 100 should not be interpreted as having a dependency or requirement relating to any one or combination of the illustrated components.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, an input/output module or BIOS 109, and a memory 115. The computer 101 typically includes a variety of computer readable media. The computer readable media may be any available media that may be accessed by the computer 101 and may include both volatile and nonvolatile media and removable and non-removable media. By way of example, and not limitation, computer readable media may comprise computer storage media and communication media.

Computer storage media may include volatile and nonvolatile and removable and non-removable media implemented in any method or technology for storage of information such as computer readable instructions, data structures, program modules, or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, and any other medium that can be used to store the desired information and that can be accessed by the computer 101.

Communication media may embody computer readable instructions, data structures, program modules, and/or other data in a modulated data signal such as a carrier wave or other transport mechanism. The communication media may also include any information delivery media. A modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media. Although not shown, RAM 105 may include one or more applications representing the application data stored in RAM 105 while the computer is on and corresponding software applications (e.g., software tasks) are being executed.

The input/output module or BIOS 109 may include a microphone, keypad, touch screen, and/or stylus through which a user of the computer 101 may provide input. The input/output module or BIOS 109 may also include one or more speaker for providing audio output and a video display device for providing textual, audiovisual, and/or graphical output. Any BIOS 109 may be employed to provide a user interface.

Software may be stored within memory 115 and/or storage to provide instructions to the processor 103 for enabling the computer 101 to perform various functions. For example, the memory 115 may store software used by the computer 101, such as an operating system 117 and an associated data file 121. Alternatively, some or all of the computer executable instructions for the computer 101 may be embodied in hardware or firmware (not shown). As described in detail below, the data file 121 may provide centralized storage of data.

The computer 101 may operate in a networked environment that supports connections to one or more remote computers, such as computing devices 141 and 151. The computing devices 141 and 151 may be personal computers or servers that include many or all of the elements described above relative to the computer 101. The network connections depicted in FIG. 1 may include a local area network (LAN) 125 and a wide area network (WAN) 129 and may also include other networks. The computer 101 is connected to the LAN 125 through a network interface or adapter 123. The computer 101 may be a server and may include a modem 127 or other means for establishing communications over the WAN 129. For example, the computer 101 may connect to a WAN 129 such as the Internet 131 through a modem connection. The network connections may include any communications link between computers.

The existence of various well-known protocols such as TCP/IP, Ethernet, FTP, HTTP, and the like is presumed, and the system can be operated in a client-server configuration to permit a user to retrieve web pages from a web-based server. Any of various conventional web browsers can be used to display and manipulate data on web pages.

Additionally, an application program may be used by the computer 101 according to an embodiment of the invention. The application program may include computer executable instructions for invoking user functionality related to communication, such as email, short message service (SMS), and voice input and speech recognition applications.

The computing devices 141 or 151 may also be mobile terminals including various other components, such as a battery, speaker, and antennas (not shown). The input/output module or BIOS 109 may include a user interface including such physical components as a voice interface, one or more arrow keys, joystick, data glove, mouse, roller ball, touch screen, or the like.

Each of the plurality of computing devices 141, 151 may contain software for creating a data file 121. The software may be a set of detailed computer-executable instructions for the computing devices 141, 151. The software may provide the computing devices 141, 151 with the ability to create a data file 121. The data file 121 may contain multiple individual files of information. For example, a plurality of user devices may be operated by a financial institution or other business entity and information relating to each user device may be received onto a computer network. The information relating to each user device may be separately contained in a unique data file 121. One or more of the data files relating to a plurality of user devices may be coupled to each other in any suitable fashion.

The computer 101 may include memory 115 for storing computer-readable instructions and a processor 103 for executing the computer-executable instructions. The computer-executable instructions may be data in the form of program source code that may be capable of modifying the data file 121. The computer-executable instructions may be a series or sequence of instructions for a computing device that is typically in the form of a programming language such as C++, Java, SQL, or the like. Various computer programming languages may be used to create the computer-executable instructions, and the invention is not limited to the programming languages listed above.

The memory 115 may be a portion of the computer 101 that stores data or other instructions. The memory 115 may be retained or lost when power is lost to the system. The memory 115 may provide access to data for a user or computing device 141, 151 to revise and manage a data file 121.

The processor 103 may be capable of executing the computer-executable instructions. The computer-executable instructions may be executed by the processor 103 after they have been stored in the memory 115. The processor 103 may be a centralized element within a computing system that is capable of performing computations. For example, the processor 103 may perform the computations that are described in the computer-executable instructions and then execute the computer-executable instructions. The computer-executable instructions may include data describing changes to the data file 121 that were made by a user or computing device 141, 151 over a computer network, such as the Internet 131. The computer 101 stores the data in the data file 121 that may be associated with a user device. The data file 121 may be stored in the memory 115 so that it may be accessible to a plurality of computing devices 141, 151 and/or users.

Data relating to a user device may be stored in the data file 121. Security precautions may be implemented to prevent unauthorized access to the data file 121. A user identification and a password may be required to access the data file 121 and/or the data relating to the user device. Some of the data that is stored in the data file 121 may be shared between multiple data files. Any desirable security precautions may be implemented.

The computer-executable instructions may be a series or sequence of instructions for a computing device 141, 151, described in detail throughout this disclosure. The processor 103 may be configured to execute the computer-executable instructions that may be used to service a user device. Such computer-executable instructions may be located (e.g., physically or logically) in modules in the memory 115. The computer network 131 may be any network that interconnects users and/or computing devices 141, 151. According to at least one aspect of the invention, the computer network 131 may provide shared access by two computing devices to at least a portion of the data in the plurality of modules. Shared access may be two or more computing devices 141, 151 that may be coupled to the computer network 131 and/or that may be able to communicate with each other and/or access, change, and add data to a data file 121.

A computer network such as the Internet 131 provides access to the data file 121 that may be shared between the computing devices 141, 151. Additionally, the computer network may be public or private and may be wired or wireless. The computing devices 141, 151 that are coupled to the computer network may be any electronic device that is capable of connecting to a computer network and transmitting data over the computer network. Further, the computing devices are capable of receiving data for entry into a data file 121 that may be associated with servicing a user device.

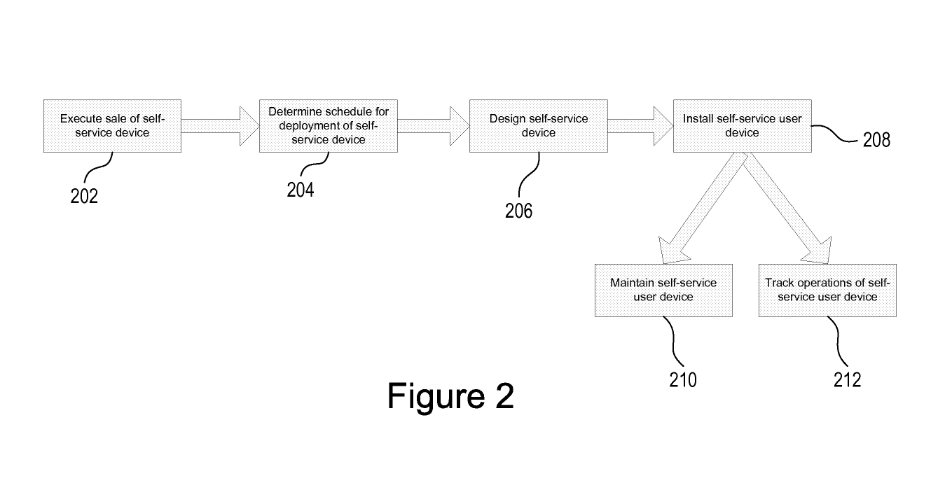

FIG. 2 illustrates a flowchart of an example method of managing a self-service user device. In step 202, a sale for a self-service user device is executed. As described above, the sale of the self-service user device may be executed in any suitable fashion. A schedule may be determined in step 204. The schedule may include tasks and/or action items that need to be executed during deployment of the self-service user device. The self-service user device may be designed including selection of the hardware and the software that may be implemented in the self-service user device in step 206. As describe above, a user interface may be selected for the self-service user device. Any feature of the design of the self-service user device may be customized.

In step 208, the self-service user device may be installed. Installation may include physically installing hardware at the self-service user device site and electronically installing software on the self-service user device. Installation may also include installing hardware or software that facilitates the electronic connection between the self-service user device and the self-service user device management system (e.g., routers, switches, servers, cable, etc.).

Step 210 includes maintaining the self-service user device. In some examples, the maintenance may be performed when a repair is needed. In other examples, the maintenance may be preventative and/or may be performed periodically. In step 212, the operations of the self-service user device may be tracked. As described in detail above, the tracking may include financial tracking, compliance tracking, security tracking, user tracking, or the like.

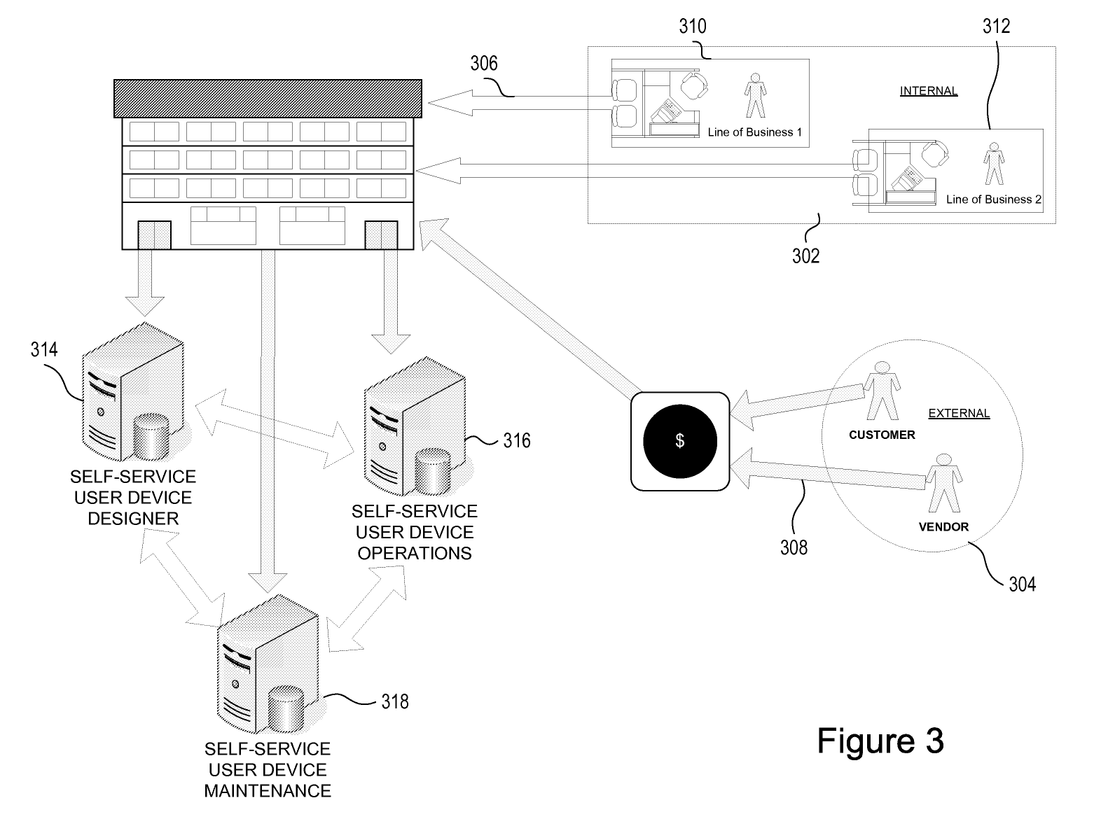

FIG. 3 illustrates an example of a self-service user device management system. Internal sources 302 and external sources 304 may access the self-service user device management system. The internal sources 302 may be coupled directly to the self-service user device management system through a self-service user device network. One or more users or groups of users may be connected to the self-service user device management system through the self-service user device network 306. The self-service user device management system may require that a user is authorized before being permitted to directly access to the self-service user device network 306. Many users that connect to the self-service user device management system through the internal sources 302 are employees, vendors, or other authorized users.

Other users may access the self-service user device management system through an external network. The external sources 304 may access the self-service user device management system through a computer network, such as the Internet rather than the self-service user device network. The external sources 304 may be required to provide security information before they are permitted to access the self-service user device management system.

Any information obtained through the management of one or more self-service user device may be shared between authorized users. For example, FIG. 3 illustrates a first line of business 310 and a second line of business 312 that may access the self-service user device management system through an internal network 302, such as a self-service user device network hosted and operated by a business entity, such as a financial institution. The first line of business 310 and the second line of business 312 may be responsible for performing a first function and a second function, respectively, that both relate to the self-service user device. However, some of the information that is obtained, entered, collected, or otherwise monitored during the performance of the first function and the second function may overlap or be redundant. Some portions of the tasks that may be required for performance of the first function and the second function also may be similar or the same. In this scenario, information may be shared between the first line of business 310 and the second line of business 312.

Further, tasks or action items may be completed and such information may be shared between a first line of business 310 and a second line of business 312. As illustrated in FIG. 3, the self-service user device management system may have a self-service user device designer module 314, a self-service user device operations module 316, and a self-service user device maintenance module 318. Information entered by an internal source 302 and/or an external source 304 may be compiled in the self-service user device management system. The self-service user device management system integrates information entered from each of the self-service user device designer module 314, the self-service user device operations module 316, and the self-service user device maintenance module 318. The flow of information and the execution of tasks between each entity, user, or self-service user device module may be shared.

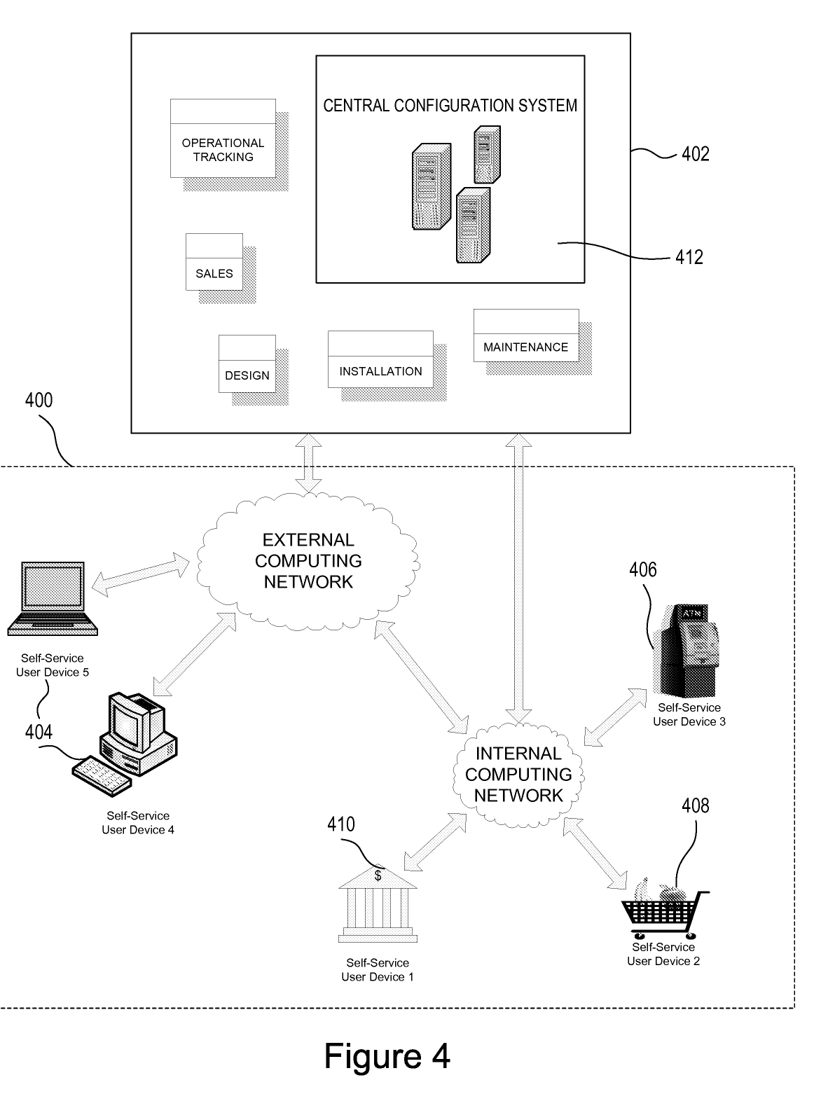

FIG. 4 illustrates a fleet 400 of user devices that may be supported by the self-service user device management system 402. The fleet 400 may comprise a plurality of self-service user devices including but not limited to a computing device 404 (self-service user device 1 and 2), an ATM at an office 406 (self-service user device 3), an ATM at a grocery store 408 (self-service user device 2), and an ATM at a financial institution 410 (self-service user device 1). Each of the self-service user devices within the fleet 400 may be managed by the self-service user device management system 402 in a central configuration system 412. The central configuration system 412 may be capable of identifying information that may be shared between the self-service user devices.

Aspects of the invention have been described in terms of illustrative embodiments thereof. Numerous additional embodiments, modifications, and variations may exist that remain within the scope and spirit of the appended claims. For example, the steps illustrated in the figures may be performed in other than the recited order and that one or more steps illustrated may be optional. The methods and systems of the above-referenced embodiments may also include other additional elements, steps, computer executable instructions, or computer-readable data structures. In this regard, other embodiments are disclosed herein as well that can be partially or wholly implemented on a computer readable medium, for example, by storing computer executable instructions or modules or by utilizing computer readable data structures.

We claim:

1. A method of managing a self-service user device, comprising:
receiving information relating to an order for a self-service user device;
designing the self-service user device;
selecting the site for the self-service user device;
installing the self-service user device at the site;
configuring the self-service user device to a self-service user device management system for managing a plurality of self-service user devices;
deploying the self-service user device so that it is operational with the self-service user device management system; and
maintaining a self-service user device during operation of the self-service user device;
wherein the self-service user device profile includes one or more self-service user device operational activities related to the self-service user device, each of the self-service user device operational activities having one or more action items managed by the self-service user device management system.

2. The method of claim 1, where the step of receiving information relating to an order for a self-service user device includes the sale of the self-service user device.

3. The method of claim 1, where the self-service user device operational activities include one of design, installation, removal, relocation, upgrading, remodeling, maintenance, and operational tracking.

4. The method of claim 1, where the step of designing the self-service user device includes selecting at least one of a hardware and a software.

5. The method of claim 1, where the step of designing the self-service user device includes selecting a user interface.

6. The method of claim 1, where the self-service user device is managed by a business entity and the site for the self-service user device is positioned at or near the business entity.

7. The method of claim 6, where the business entity is a financial institution.

8. The method of claim 1, further comprising performing operational tracking, the operational tracking including tracking financial transactions that occur at the self-service user device.

9. The method of claim 1, where the step of maintaining the self-service user device includes a repair, a routine maintenance, and a preventative maintenance.

10. The method of claim 1, further comprising sharing the self-service user device information between a first line of business and a second line of business.

11. The method of claim 1, further comprising the self-service user device is at least one of an automated teller machine, an account management kiosk, a point-of-sale terminal, and a cash recycler.

12. The method of claim 1, further comprising compiling status information relating to each of the self-service user device operational activities.

13. The method of claim 12, further comprising generating a report that includes the status information.

14. The method of claim 12, where the report is generated periodically.

15. The method of claim 1, where at least one of the self-service user device operational activities includes at least one of asset management, productivity monitoring, manage workflow, gather information relating to one or more self-service user devices, issue notification tasks, maintenance, and compliance.

16. The method of claim 1, further comprising updating the self-service user device profile when a self-service user device operational activity is added, changed, deleted, or completed.

17. The method of claim 1, where the first action item is completed before the second action item.

18. The method of claim 17, where the second action item is created at least partially based upon the status information relating to the first action item.

19. The method of claim 1, where the step of maintaining the self-service user device includes at least one of a repair, a routine maintenance, and a preventative maintenance.

20. A method of managing a fleet of self-service user devices operated by a business entity, comprising:
receiving a request at a central management system for a new self-service user device to be added to the fleet of self-service user devices, the new self-service user device positioned at a self-service user device site;
designing the new self-service user device;
installing the new self-service user device at the self-service user device site;
configuring the new self-service user device with the central management system, the central management system capable of integrating order, deployment, operational management, and maintenance of the fleet of self-service user devices;
compiling information relating to the order, the deployment, the operational management, and the maintenance of each of the self-service user devices in the fleet; and
storing the information in a self-service user device profile that is accessible by a plurality of users, the self-service user device profile stored on a server positioned at a remote location from the new self-service device;
wherein the central management system is accessible by at least two users, the central management system and the fleet of self-service user devices operated by a business entity.

22. A computer-readable medium comprising computer-executable instructions to perform a method, comprising:
receiving a request at a central management system for a new self-service user device to be added to a fleet of self-service user devices, the new self-service user device positioned at a self-service device site;
designing the new self-service user device;
installing the new self-service user device at the self-service device site;
configuring the new self-service user device with the central management system, the central management system capable of integrating maintaining self-service user device information relating to order, deployment, operational management, and maintenance of the fleet of self-service user devices;
compiling the self-service user device information relating to the order, the deployment, the operational management, and the maintenance of each of the self-service user devices in the fleet;
storing the information in a self-service user device profile that is accessible by a plurality of users, the self-service user device profile stored on a server positioned at a remote location from the new self-service device;
wherein the central management system is accessible by at least two users, the central management system and the fleet of self-service user devices operated by a business entity.
